(19) United States
(12) Patent Application Publication
(10) Pub. No.: US 2007/0119281 A1
(43) Pub. Date: May 31, 2007

(54) One-way open-ended wrench

(76) Inventor: Hui-Ling Chang, Taichung County (TW)

Correspondence Address: CHARLES E. BAXLEY, ESQ., 90 JOHN STREET, THIRD FLOOR, NEW YORK, NY, 10038, US

(21) Appl. No.: 11/290,323

(22) Filed: Nov. 29, 2005

(51) Int. Cl. B25B 13/12

(52) U.S. Cl. 81/179; 81/126; 81/186

(57) ABSTRACT

A one-way open-ended wrench includes a handle and a head formed on the handle. The head includes a first fixed jaw and a second fixed jaw. The first fixed jaw can contact a selective facet of a fastener. The second fixed jaw includes a tunnel and a stop on the wall of the tunnel. A movable jaw is movable in the tunnel, and includes a normal abutment facet, a sliding facet and a slant abutment facet. The normal abutment facet can abut the stop. The sliding facet can slide on the opposite facet of the fastener so that movable jaw can be pushed into the tunnel by the fastener. The slant abutment facet can abut the opposite facet of the fastener so that the movable jaw and the first fixed jaw can clamp the fastener. In the tunnel is a spring for biasing the movable jaw.

### BACKGROUND OF INVENTION

1. Field of Invention

The present invention relates to a one-way open-ended wrench and, more particularly, to a one-way open-ended wrench that is made with a simple structure, operable conveniently, and assembled from inexpensive parts in an inexpensive process.

2. Related Prior Art

Typically, a nut or a head of a bolt is tightened or loosened by means of a wrench such as a ratchet wrench (or “selective one-way wrench”), a socket wrench, an adjustable wrench (or “coach wrench” or “monkey wrench”), a box-ended wrench and an open-ended wrench. The tightening and loosening are conducted through rotation. Where an entire revolution is impossible, a wrench must be disengaged from the nut or the head of the bolt after driving for an angle, returned, and engaged with the nut or the head of the bolt again so that the wrench can drive the nut or the head of the bolt for another angle. Thus, the tightening and loosening can be conducted to a desired extent. This procedure is however inconvenient. This is where the ratchet wrenches are introduced. Sometimes, a limited room renders it impossible to disengage a wrench from the nut or the head of the bolt axially. In such a limited room, only an open-ended wrench can be used. A conventional open-ended wrench is thin, and cannot include a ratchet mechanism (or “one-way mechanism”).

To solve the fore-going problem, there are devised open-ended wrenches equipped with ratchet mechanisms such as shown in FIG. 6 (corresponding to Taiwanese Patent Publication M262313, “Open-Ended Wrench with Ratchet Functions”). The open-ended wrench includes a handle 50 and a head 51 formed at an end of the handle 50. The head 51 includes first and second jaws 52 between which is a space. The first jaw 52 defines a hole and a tunnel. A spring 55 and a movable jaw 54 are positioned in the hole. The spring 55 is compressed between the bottom of the hole and the movable jaw 54. The movable jaw 54 defines a groove 540. A guiding rod 56 is positioned in the tunnel. An end of the guiding rod 56 is positioned in the groove 540. A spring 57 is positioned in the tunnel. An opposite end of the guiding rod 56 is in contact with the spring 55. The thread of a bolt is engaged with a thread formed on the wall of the tunnel. Thus, the spring 57 is compressed between the guiding rod 56 and the bolt. When the open-ended wrench is driven in a direction, the movable jaw 54, restrained by means of the guiding rod 56, cooperates with the second jaw 52 in order to clamp and drive a nut or a head of a bolt. When the open-ended wrench is driven in an opposite direction, the movable jaw 54, not restrained by means of the guiding rod 56, is pushed into the hole by means of the nut or the head of the bolt, thus leaving the nut or the head of the bolt where it is.

There are two problems with this open-ended wrench with ratchet functions. Firstly, it is made with a complicated structure from a lot of parts. The parts cannot be made easily. The open-ended wrench cannot be assembled from the parts easily. Therefore, the open-ended wrench is expensive. Secondly, the stroke of the movable jaw 54 must be limited by means of the guiding rod 56. Hence, the movable jaw 54 must be positioned to the upper portion of the first jaw 52, and the free end of the movable jaw 54 comes into contact with a portion upstream to the center of a facet of the nut or the head of the bolt. The nut or the head of the bolt may not receive an adequate torque from the movable jaw 54. Moreover, the movable jaw 54 may be damaged so that its lifecycle is reduced.

As mentioned above, because of poor designs, existing open-ended wrenches with ratchet functions include complicated structures, involve high costs, transfer inadequate torques and last for short lifecycles.

The present invention is therefore intended to obviate or at least alleviate the problems encountered in prior art.

### SUMMARY OF INVENTION

The primary objective of the present invention is to provide a structurally simple one-way open-ended wrench in order to reduce the cost in manufacturing and assembling, thus improving its economic effectiveness.

According to the present invention, a one-way open-ended wrench includes a handle and a head. The head includes a first fixed jaw and a second fixed jaw. The first fixed jaw can contact a selective facet of a fastener. The second fixed jaw includes a tunnel and a stop on the wall of the tunnel. A movable jaw is movable in the tunnel. The movable jaw includes a normal abutment facet, a sliding facet near the normal abutment facet and a slant abutment facet near the sliding facet. The normal abutment facet can abut the stop. The sliding facet can slide on the opposite facet of the fastener so that movable jaw can be pushed into the tunnel by means of the fastener. The slant abutment facet can abut the opposite facet of the fastener so that the movable jaw and the first fixed jaw can clamp the fastener. In the tunnel is a spring for biasing the movable jaw.

Other objectives, advantages and novel features of the present invention will become more apparent from the following detailed description referring to the attached drawings.

### BRIEF DESCRIPTION OF DRAWINGS

The present invention will be described through illustration of the preferred embodiment referring to the drawings.

FIG. 1 is a perspective view of a one-way open-ended wrench according to the preferred embodiment of the present invention.

FIG. 2 is an exploded view of the one-way open-ended wrench shown in FIG. 1.

FIG. 3 is a cutaway view of the one-way open-ended wrench shown in FIG. 1.

FIG. 4 is an enlarged partial view of the one-way open-ended wrench shown in FIG. 3 while driving a head of a bolt in a direction.

FIG. 5 is a view of the one-way open-ended wrench rotated in a direction opposite to that is shown in FIG. 4.

FIG. 6 is a cutaway partial view of a conventional one-way open-ended wrench.

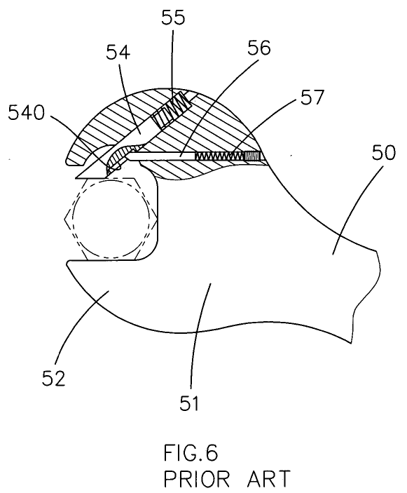

### DETAILED DESCRIPTION OF PREFERRED EMBODIMENT

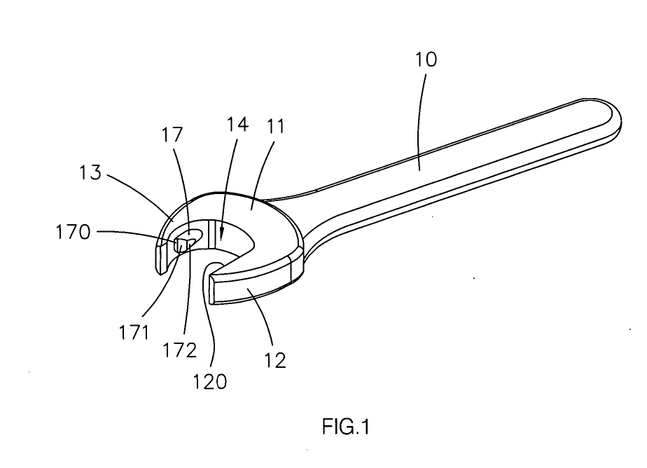

Referring to FIG. 1, there is shown a one-way open-ended wrench including a handle 10 and at least one head 11 formed at one of two ends of the handle 10. The head 11 includes a first fixed jaw 12 and a second fixed jaw 13. There is a space 14 defined between the first fixed jaw 12 and the second fixed jaw 13.

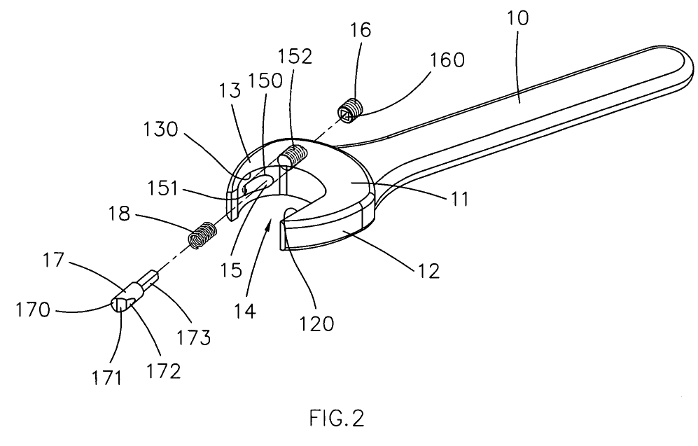

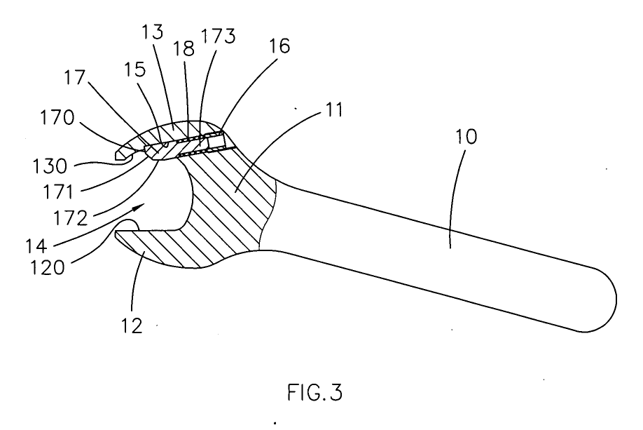

Referring to FIGS. 1 through 4, the first fixed jaw 12 includes a flat surface 120 for contact with a selective facet 21 of a nut or a head of a bolt 20. The second fixed jaw 13 includes a concave surface 130 for allowing the rotation of the nut or the head of the bolt 20 in the space 14. The second fixed jaw 13 defines a tunnel 15 with a first opening 150 in the concave surface 130 and a second opening opposite to the first opening 150. A stop 151 is formed on the wall of the tunnel 15 near the first opening 150. A thread 152 is formed on the wall of the tunnel 15 near the second opening. The thread of a bolt 16 is engaged with the thread 152. The bolt 16 defines a central non-circular hole 160. Preferably, the non-circular hole 160 is a square hole.

A movable jaw 17 is movable in the tunnel 15. The movable jaw 17 includes a head and a tail 173 extending from the head. The head of the movable jaw 17 includes a normal abutment facet 170, a sliding facet 171 near the normal abutment facet 170 and a slant abutment facet 172 near the sliding facet 171. The tail 173 includes a non-circular cross-sectional profile. The non-circular cross-sectional profile is preferably square corresponding to the non-circular hole 160.

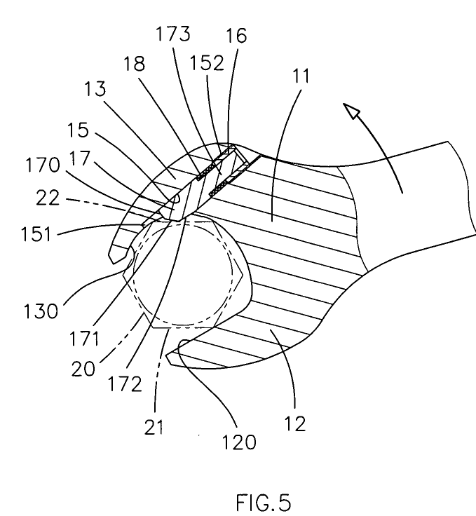

The normal abutment facet 170 is used for abutment against the stop 151 formed on the wall of the tunnel 15. Thus, the movement of the movable jaw 17 is confined between the bolt 16 and the stop 151. The sliding facet 171 is used for smooth sliding on an opposite facet 22 of the nut or the head of the bolt 20 as shown in FIG. 5. The slant abutment facet 172 is used for abutment against a portion downstream to the center of the opposite facet 22 when the head of the movable jaw 17 is positioned at the opening 150. The term “downstream” is used based on the intended driving direction of the one-way open-ended wrench.

The non-circular tail 173 is inserted into the non-circular hole 160 through a spring 18. The spring 18 is preferably helical. The spring 18 is compressed between the head of the movable jaw 17 and the bolt 16. The non-circular tail 173 can slide smoothly in the non-circular hole 160 so that the movable jaw 17 can move smoothly but cannot rotate.

As described above, the one-way open-ended wrench includes a simple structure and can transfer an adequate torque.

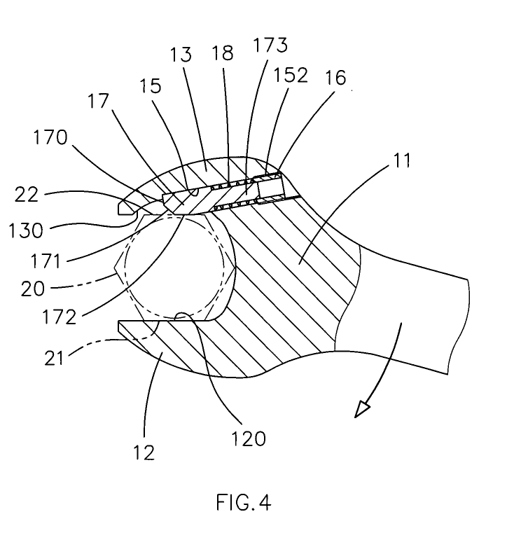

Referring to FIG. 4, when a user drives the one-way open-ended wrench in the intended driving direction as indicated by means of an arrowhead, the slant abutment facet 172 of the movable jaw 17 abuts the opposite facet 22. The contact surface 120 of the first fixed jaw 12 abuts the selective facet 21. Thus, the user can clamp the nut or the head of the bolt 20 by means of the movable jaw 17 and the first fixed jaw 12, and then tighten the same.

Referring to FIG. 5, when the user drives the one-way open-ended wrench in a direction opposite to the intended driving direction as indicated by means of an arrowhead, the sliding facet 171 of the movable jaw 17 slides on the opposite facet 22. The opposite facet 22 pushes the movable jaw 17 into the tunnel 15. The movement of the movable jaw 17 causes the compression of the spring 18. The opposite facet 22 sweeps over the concave surface 130. The contact surface 120 of the first fixed jaw 12 abuts the selective facet 21. Thus, the user will not rotate the nut or the head of the bolt 20 in the direction opposite to the intended driving direction. When the head of the movable jaw 17 is moved beyond the opposite facet 22, the head of the movable jaw 17 is pushed from tunnel 15 by means of the spring 18. Thus, the one-way open-ended wrench is ready for driving the nut or the head of the bolt 20 for another angle in the intended driving direction.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A one-way open-ended wrench comprising:
a handle;
at least one head formed at one of two ends of the handle, the head comprising a first fixed jaw for contact with a selective facet of a fastener and a second fixed jaw comprising a tunnel and a stop on the wall of the tunnel;
a movable jaw movable in the tunnel, the movable jaw comprising:
a normal abutment facet for abutment against the stop;
a sliding facet near the normal abutment facet, wherein the sliding facet can slide on the opposite facet of the fastener so that movable jaw can be pushed into the tunnel by means of the fastener; and
a slant abutment facet near the sliding facet, wherein the slant abutment facet can abut the opposite facet of the fastener so that the movable jaw and the first fixed jaw can clamp and rotate the fastener; and
a spring positioned in the tunnel for biasing the movable jaw.

2. The one-way open-ended wrench according to claim 1 comprising a bolt, wherein the second fixed jaw comprises a thread on the wall of the tunnel for engagement with the thread of the bolt in order to restrain the movement of the movable jaw.

3. The one-way open-ended wrench according to claim 1 wherein the movable jaw comprises a tail inserted through the spring in order to ensure smooth movement of the movable jaw.

4. The one-way open-ended wrench according to claim 2 wherein the movable jaw comprises a tail inserted through the spring in order to ensure smooth movement of the movable jaw.

5. The one-way open-ended wrench according to claim 4 wherein the bolt defines a hole for receiving the tail of the movable jaw.

6. The one-way open-ended wrench according to claim 5 wherein the hole defined in the bolt is non-circular, wherein the tail of the movable jaw comprises a corresponding non-circular cross-sectional profile in order to prevent the rotation of the movable jaw.

7. The one-way open-ended wrench according to claim 6 wherein the non-circular hole defined in the bolt is square, wherein the tail of the movable jaw comprises a corresponding square cross-sectional profile in order to prevent the rotation of the movable jaw.

8. The one-way open-ended wrench according to claim 1 wherein the first fixed jaw comprises a flat surface for contact with the selective facet of the fastener.

9. The one-way open-ended wrench according to claim 1 wherein the second fixed jaw comprises a concave surface over which the opposite facet of the fastener can sweep.
